(19) United States
(12) Patent Application Publication
(10) Pub. No.: US 2015/0039749 A1
(43) Pub. Date: Feb. 5, 2015

(54) DETECTING TRAFFIC ANOMALIES BASED ON APPLICATION-AWARE ROLLING BASELINE AGGREGATES

(71) Applicant: ALCATEL-LUCENT CANADA INC., Ottawa (CA)

(72) Inventors: Louie Kwan, Kanata (CA); Neeraj Chandra, Kanata (CA); Phil Rackus, Kanata (CA); Ajay Pandya, Ottawa (CA); Ahmed Hammad, Ottawa (CA)

(73) Assignee: ALCATEL-LUCENT CANADA INC., Ottawa (CA)

(21) Appl. No.: 13/956,886

(22) Filed: Aug. 1, 2013

(51) Int. Cl. H04L 12/26

(52) U.S. Cl. CPC H04L 43/0876
USPC 709/224

(57) ABSTRACT

Various exemplary embodiments relate to a method of detecting anomalies in network traffic. The method includes: receiving a plurality of accounting reports from an application assurance device, the accounting reports indicating a metric of network performance; aggregating the metric from a plurality of accounting reports to determine a plurality of aggregated metrics corresponding to a plurality of intervals; storing the aggregated metrics in a database in association with the corresponding plurality of intervals; determining a rolling baseline for a current time period based on metrics of intervals corresponding to a primary partition and a sub-partition; comparing a metric for a current time period to the rolling baseline; and determining that an anomaly is occurring if the metric for the current time period differs from the rolling baseline by more than a pre-defined threshold.

### TECHNICAL FIELD

Various exemplary embodiments disclosed herein relate generally to communications networks.

### BACKGROUND

Both wireline and wireless networks have unique limited resources with which to support the growing demand of data subscribers. Network resources must be conserved and managed carefully to meet the ever-growing demands upon the network. A number of products provide a network based application assurance solution through in-line application inspection, reporting and policy control. For example, application level monitoring may allow residential subscribers or business with virtual private networks (VPNs) to understand which of the many applications used are consuming the most bandwidth. Network operators can quickly identify applications and applications groups with high-bandwidth usage trends for a given time.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of detecting anomalies in network traffic. The method includes: receiving a plurality of accounting reports from an application assurance device, the accounting reports indicating a metric of network performance; aggregating the metric from a plurality of accounting reports to determine a plurality of aggregated metrics corresponding to a plurality of intervals; storing the aggregated metrics in a database in association with the corresponding plurality of intervals; determining a rolling baseline for a current time period based on metrics of intervals corresponding to a primary partition and a sub-partition; comparing a metric for a current time period to the rolling baseline; and determining that an anomaly is occurring if the metric for the current time period differs from the rolling baseline by more than a pre-defined threshold.

In various embodiments, the primary partition and the sub-partition may be cyclical. The primary partition may be the day of the week and the sub-partition may the interval within the day. The interval may be an hour. The metric in the accounting reports may define a metric for a sub-interval.

In various embodiments, the accounting reports indicate a metric of network performance in relation to an application.

In various embodiments, the accounting reports indicate a metric of network performance in relation to a subscriber.

In various embodiments, the step of determining a rolling baseline for a current time period includes calculating a weighted average of aggregated metrics for intervals corresponding to the primary partition and sub-partition of the current time period. The weighted average may apply a decayed weighting function to the aggregated metrics according to the age of each interval. The weighted average may include an operator selected weighted component.

In various embodiments, the method further includes displaying a graph comparing the rolling baseline to the metrics for a plurality of recent current time periods.

Various exemplary embodiments relate to an analysis server for detecting network anomalies. The analysis server may include: a router interface configured to receive a plurality of accounting reports from an application assurance device, the accounting reports indicating a metric of network performance; a non-transitory database configured to store aggregated metrics from a plurality of accounting reports in association with a corresponding plurality of intervals; a baseline calculator configured to determine a rolling baseline for a current time period based on a subset of the stored aggregated metrics having intervals corresponding to a primary partition and a sub-partition of the current time period; and an anomaly detector configured to compare a metric for a current time period to the rolling baseline and determine that an anomaly is occurring if the metric for the current time period differs from the rolling baseline by more than a pre-defined threshold.

In various embodiments, the analysis server further includes an operator interface including a display configured to display a graph comparing the rolling baseline to the metrics for a plurality of recent current time periods.

In various embodiments, the analysis server further includes a metric aggregator configured to aggregate a plurality of metrics from a plurality of accounting reports and assign a partition and sub-partition to each aggregated metric.

In various embodiments, the baseline calculator is configured to determine the rolling baseline for a current time period by calculating a weighted average of aggregated metrics for intervals corresponding to the primary partition and sub-partition of the current time period. The baseline calculator may apply a decayed weighting function to the aggregated metrics according to the age of each interval.

Various exemplary embodiments relate to a non-transitory machine-readable storage medium encoded with instructions executable by a processor of an analysis server for performing the method described above.

It should be apparent that, in this manner, various exemplary embodiments enable application-aware anomaly detection. In particular, by using rolling baselines indicating normal network performance for a given time, an analysis server may identify anomalies in current network performance in a continuous and self-managed manner.

### BRIEF DESCRIPTION OF THE DRAWINGS

In order to better understand various exemplary embodiments, reference is made to the accompanying drawings, wherein:

FIG. 1 illustrates an exemplary network environment;

FIG. 2 illustrates an exemplary analysis server;

FIG. 3 illustrates an exemplary data arrangement for a network metric database;

FIG. 4 illustrates a flowchart showing an exemplary method of detecting network anomalies; and

FIG. 5 illustrates an exemplary chart comparing measurements to a rolling baseline.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended to be for pedagogical purposes, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

With application assurance solutions, network operators have visibility into segments of their network, but such visibility also comes with voluminous amounts of data. The advent of such voluminous data means that analyzing large amounts of data is going to be an increasingly difficult challenge for network operators.

Network traffic is not static and many studies indicate that most of the time, traffic patterns are mainly time related, e.g. there are different traffic patterns on weekdays and weekends. Because of largely standardized working hours, there is a sharply peaked demand at times associated work hours for work related applications traffic. For about eight hours a day, between 9 am and 5 pm, real time related traffic demand like VOIP could cause stress on the networks. However, this level of VOIP traffic demand drops drastically during other parts of the day. Accordingly, it may be useful for traffic anomaly detection to be based on time of day.

In view of the foregoing, it would be desirable to provide application-aware anomaly detection. In particular, it would be desirable to use rolling baselines indicating normal network performance for a given time to identify anomalies in current network performance in a continuous and self-managed manner.

Referring now to the drawings, in which like numerals refer to like components or steps, there are disclosed broad aspects of various exemplary embodiments.

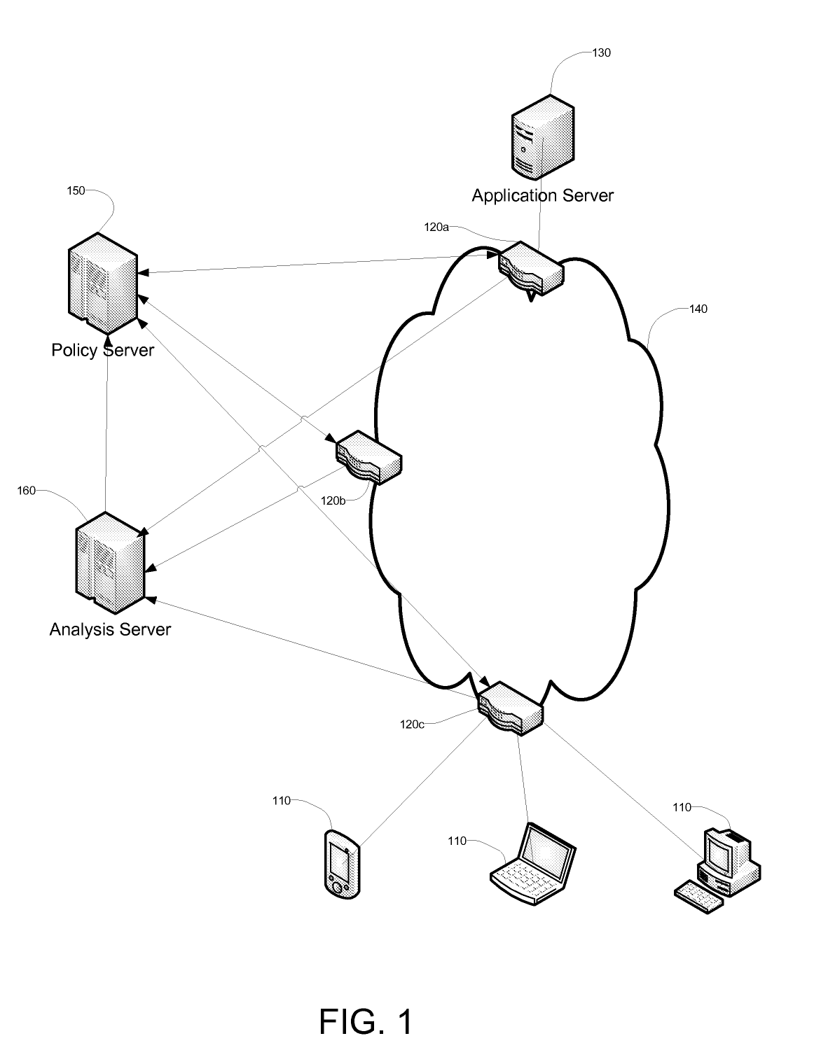

FIG. 1 illustrates an exemplary network environment 100. Exemplary network environment 100 may include a communications network operated by a network provider who provides network services for subscribers. For example, network environment 100 may be a network operated by an internet service provider or a mobile network operator. Exemplary network environment 100 may include user equipment 110, routers 120, application servers 130, network 140, policy server 150, and analysis server 160.

User equipment 110 may be a device that communicates with network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via network 140. User equipment 110 may communicate with network 140 via one or more intermediate devices or network nodes.

Routers 120 may include devices that receive data packets and forward the packets toward a destination. For example, routers 120 may include service routers such as the Alcatel-Lucent 7750 SR. Routers 120 may include application aware processing abilities. For example, an application aware router 120 may include specialized hardware for inspecting data packets as they pass through the router 120. The application aware router 120 may be configured to extract information from data packets and generate reports. As will be discussed in further detail below, an application aware router 120 may provide voluminous data regarding operation of the router 120 and about network traffic. For example, an application aware router 120 may provide counters for each network application including scores for application performance, application specific metrics, and raw byte and packet counts.

Application server 130 may be a server computer configured to provide an application service to user equipment 110 via network 140. Application server 130 may host services such as websites, streaming videos, online games, voice over IP (VoIP), and any other computing service. A single application may be provided by a plurality of application servers 130. An application may also be hosted as a cloud service provided on various remotely located servers that may change over time.

Network 140 may include a plurality of network nodes and communication links for transmitting data packets between user equipment 110 and application server 130. Network 140 may include routers 120.

Policy server 150 may be a server computer configured to manage network 140. Policy server 150 may receive requests for access to network 140 from user equipment 110 and determine subscriber access and charging information. Policy server 150 may also control routers 120 to provide efficient routing. For example, policy server 150 may control filtering policies at routers 120 in order to allocate network resources among network applications and subscribers. As will be discussed in further detail below, policy server 150 may receive notifications of anomalies in network traffic and respond accordingly in order to maintain the performance of network 140.

Analysis server 160 may be a server computer configured to receive performance reports from one or more routers 120 and detect network traffic anomalies based on the received reports. As will be discussed in further detail below, analysis server 160 may receive various reports and extract and store information from the reports in order to generate a rolling baseline for a metric. Analysis server 160 may detect network traffic anomalies by comparing the rolling baseline to current performance reports. When anomalies are detected, analysis server 160 may automatically generate anomaly reports to send to a human network analyst or policy server 150. Accordingly, management actions may be taken to handle the anomalies and prevent network degradation or failure.

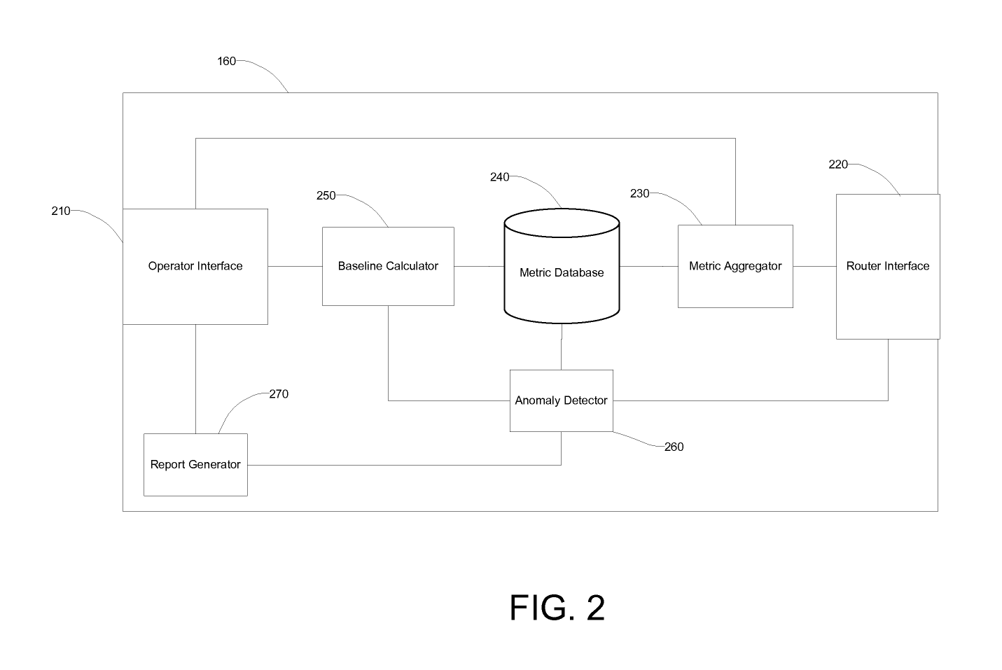

FIG. 2 illustrates an exemplary analysis server 160. Analysis server 160 may include an operator interface 210, a router interface 220, a metric aggregator 230, a metric database 240, a baseline calculator 250, an anomaly detector 260, and a report generator 270.

Operator interface 210 may include hardware and/or executable instructions encoded on a machine-readable storage medium configured to communicate with a human operator. For example, operator interface 210 may include input and output devices such as a video card, monitor, keyboard and mouse. Operator interface 210 may also be configured to communicate with an operator via a secondary networked device by sending messages such as email. As will be discussed in further detail below, the operator, who may be a network analyst, may use operator interface 210 to configure various parameters of analysis server 160 in order to perform desired analysis and product desired reports.

Router interface 220 may include hardware and/or executable instructions encoded on a machine-readable storage medium configured to receive performance reports from one or more routers 120. Performance reports may include any information provided by a router regarding the performance of the router 120 or the network 140. Various standards are known for providing information that may be considered a performance report. For example, router interface 220 may be configured to receive reports formatted according to the Internet Protocol Flow Information Export (IPFIX) protocol. Router interface 220 may also receive authentication, authorization and accounting (AAA) accounting messages. Router interface 220 may also be configured to access a router via file transfer protocol (FTP) and download performance information. Any other protocol or method for acquiring performance information may also be used. Router interface 220 may be configured to process received performance reports according to the reporting protocol and extract particular information. The operator may designate what information should be extracted based on the analysis needs of the particular network. For example, the operator may designate individual metrics for extraction and analysis or choose from a pre-configured set of metrics.

The received accounting reports may include a variety of different metrics. Example metrics may include mean opinion scores that rate the quality of experience (QoE) of subscribers. For example, mean opinion score metrics may include listening quality score, conversational quality score, audio-video mean opinion score, video service transmission quality, audio mean opinion score, and video absolute mean opinion score. Example metrics may also include application performance index (Apdex) counters such as network round trip time (RTT), mean total transaction delay, total delay standard deviation, and packet loss rate. Received metrics may also include any other metrics measured by a router. For example, the received metrics may include bytes/packets transmitted and bytes/packets discarded. It should be apparent that routers may provide a plurality of different metrics within an accounting report. Router interface 220 may extract the metrics from the accounting reports and convert them to a usable format. For example, router interface 220 may convert units or combine multiple metrics into a new metric.

Metric aggregator 230 may include hardware and/or executable instructions encoded on a machine readable storage medium configured to aggregate information received from routers 120. In various embodiments, routers 120 may report data at relatively short time intervals. For example, routers 120 may report performance metrics every 5, 10, or 15 minutes. Metric aggregator 230 may aggregate metrics over time by combining metrics into longer time periods. In various embodiments, metric aggregator 230 may aggregate a plurality of received reports into an aggregated metric for an interval of an hour. Metric aggregator 230 may partition aggregated metrics for later use. For example, metric aggregator 230 may generate an hour ID and day ID for an aggregated hourly metric to indicate the relevant time period. The day ID may indicate a partition and the hour ID may indicate a sub-partition. Metric aggregator 230 may use cyclical partitions to provide a rolling baseline metric that is relevant to a current time.

In various embodiments, metric aggregator may aggregate metrics across other dimensions. Metric aggregator 230 may combine metrics from multiple routers into a single metric for an application or subscriber. As another example, metric aggregator 230 may combine metrics from different applications into a metric for an application group. Aggregation of metrics may reduce storage space required such that additional metrics may be stored for a longer time. Aggregation of metrics as they are received from routers 120 may also allow faster processing of rolling baselines for anomaly detection. Aggregated metrics may include an average or sum of the metric for a time interval. Aggregated metrics may also include high and low values or other information that summarizes performance. Metric aggregator 230 may store aggregated metrics in metric database 240.

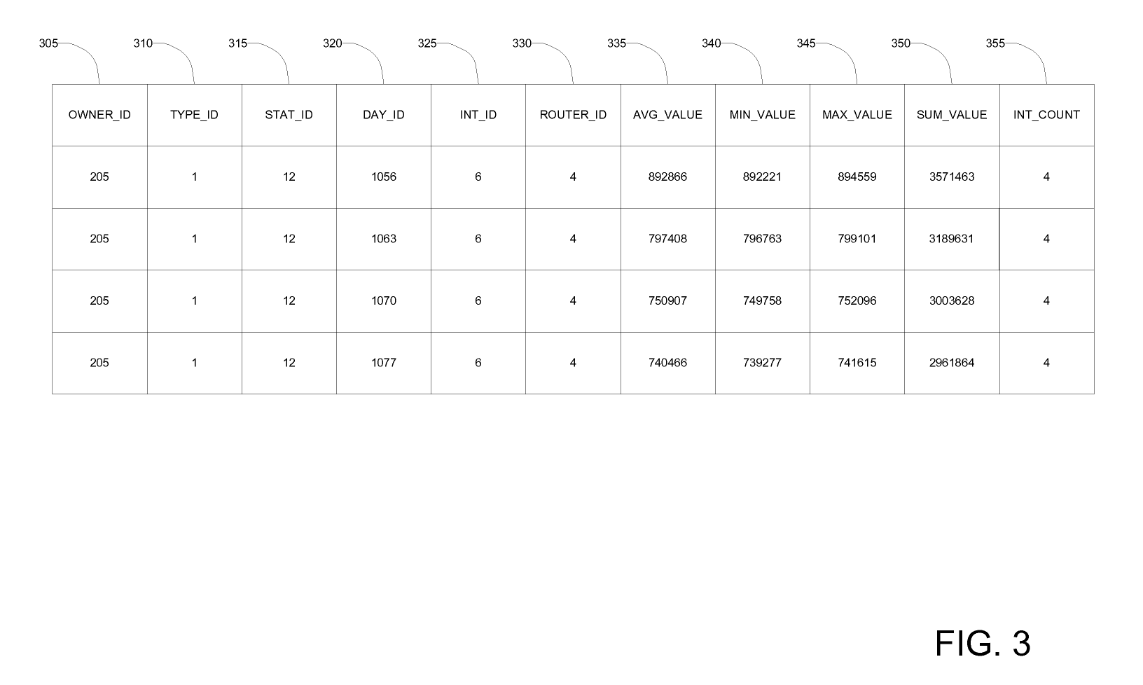

Metric database 240 may be a non-transitory machine-readable storage medium configured to store aggregated metric information. Metric database 240 may include a data structure for storing metric information in a manner that is easily accessible for determining a rolling baseline. An exemplary data arrangement for metric database 240 will be described in further detail below regarding FIG. 3.

Baseline calculator 250 may include hardware and/or executable instructions encoded on a machine-readable storage medium configured to determine a rolling baseline for a performance metric. Baseline calculator 250 may use aggregated metrics stored in metric database 240 to determine a rolling baseline that is applicable to a current time period. Accordingly, current metric information may be compared to relevant past metrics to determine whether an anomaly is occurring. The rolling baseline may be based on the observation that network traffic may be cyclical according to the day of the week and the time of day. Therefore, the baseline calculator 250 may determine a rolling baseline using aggregated metrics that correspond the current day of the week and time of day.

Various calculations may be used to determine a rolling baseline. In various embodiments, a weighted average among a set number of previous metrics may be used. The weight for each metric may be determined based on a decaying function such that more recent metrics have greater weight than older metrics. The weighted average may also include a fixed weighted value defined by an operator. Accordingly, an operator may weight the baseline according to a perceived optimal value or a value based on network capacity.

Anomaly detector 260 may include hardware and/or executable instructions encoded on a machine-readable storage medium configured to determine whether current network metric measurements represent an anomaly compared to the rolling baseline. Anomaly detector 260 may compare recent performance metrics to a rolling baseline for the same metrics. The recent performance metrics may include an aggregated metric for the most recent interval or the metrics of a most recent report. If metrics from a single report are being used, the metric may be extrapolated for comparison to a baseline for a longer interval. In various embodiments, the Anomaly detector 260 may determine whether the current measurement varies significantly from the rolling baseline. The anomaly detector may use a percentage, threshold, or other statistical method to determine whether a difference between the current measurement and the rolling baseline is significant. The operator may set the percentage or threshold for each metric that is being evaluated.

Report generator 270 may include hardware and/or executable instructions encoded on a machine-readable storage medium configured to report network performance and anomalies to an operator or policy server 150. Report generator 270 may generate a report viewable by an operator that includes comparisons of the current metric measurements with rolling baselines. The report may include a graph, a table, csv, xml or csv format report. A report to a human operator may include a graph showing movement of both the rolling baseline and the most recent performance measurements. Report generator 270 may also send reports to policy server 150. Reports to a policy server may indicate only anomalies that have been detected. Accordingly, policy server 150 may automatically take management actions based on detected anomalies.

FIG. 3 illustrates an exemplary data arrangement 300 for a network metric database 240. Exemplary data arrangement 300 is illustrated as a table. It should be apparent that other data structures may be used for storing information. Data arrangement 300 may include a number of fields for storing data related to network performance. A plurality of fields may be used to identify the particular performance metric stored. For example, OWNER_ID field 305, TYPE_ID field 310, STAT_ID field 315, DAY_ID field 320 INT_ID field 325, and ROUTER_ID field 330 may be used to designate a particular set of data. As will be described in further detail below, baseline calculator 240 may use these fields to select data to calculate the rolling baseline. Other fields such as AVG_VALUE field 335, MIN_VALUE field 340, MAX_VALUE field 345, SUM_VALUE field 350, and INT_VALUE field 355 may be fields for storing aggregated metric information. Data arrangement 300 may include a plurality of entries 370. Each entry may correspond to a set of aggregated metrics.

OWNER_ID field 305 may indicate an owner of a particular set of metric data. The owner may be a particular network analyst who requested collection of the data. TYPE_ID field 310 may indicate a type of the metric. Analysis server 160 may assign a TYPE_ID to each statistical counter that is available for analysis. STAT_ID field 315 may indicate a unique metric. Analysis server 160 may assign a unique STAT_ID to each statistical counter that is available for analysis. DAY_ID field 320 may indicate a day that the performance report including the metric was received. DAY_ID field 320 may include an integer designating unique days. Alternatively, DAY_ID field may indicate a day of the week by name or number. INT_ID field 325 may indicate a time interval corresponding to the aggregated metric. The INT_ID field 325 may indicate the sequential time interval of the DAY_ID field that the aggregate metric represents. ROUTER_ID field 330 may identify the router or routers that are the source of the aggregated metric. AVG_VALUE field 335 may indicate an average of the measurements for a plurality of measurement intervals that have been aggregated. MIN_VALUE field 340 may indicate the minimum value of the measurements for the plurality of measurement intervals that have been aggregated. MAX_VALUE field 345 may indicate the maximum value of the measurements for the plurality of measurement intervals that have been aggregated. SUM_VALUE field 350 may indicate the sum of the measurements for the plurality of measurement intervals that have been aggregated. INT_VALUE field 355 may indicate the number of measurement intervals that are aggregated in the aggregate metric. In various embodiments, the INT_VALUE field 355 may indicate an expected number of intervals and an actual number of intervals. Accordingly, the aggregate metric may have a record of performance reports that were not received.

The entries 370 of data arrangement 300 may indicate entries that have been selected for determining a rolling baseline. Accordingly, each of the entries 370 may have the same OWNER_ID field 305, TYPE_ID field 310, and ROUTER_ID field 330. Moreover, the INT_ID field 325 may have the same value because the rolling baseline corresponds to, for example, 6:00 AM-7:00 AM. The DAY_ID field 320, may be different for each entry 370, but may have the same value modulus 7. For example, each entry may correspond to Tuesday. Accordingly, the entries of data arrangement 370 may be used for calculating a rolling baseline for network traffic on Tuesdays between 6:00 AM and 7:00 AM.

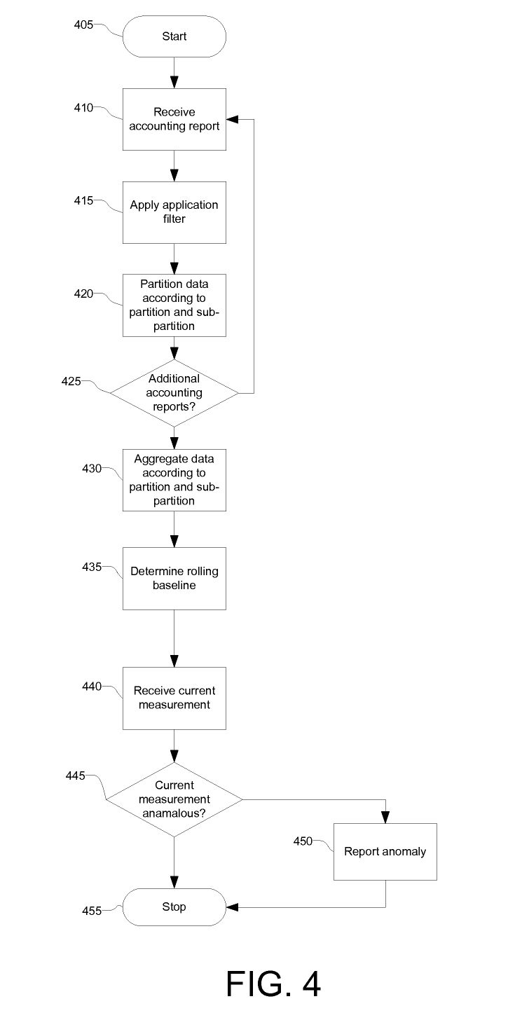

FIG. 4 illustrates a flowchart showing an exemplary method 400 of detecting network anomalies. The method 400 may be performed by the various components of analysis server 160. The method 400 will be described with respect to a single metric. It should be appreciated that an analysis server 160 may perform the method 400 for a plurality of metrics. The method 400 may begin at step 405 and proceed to step 410.

In step 410, the analysis server 160 may receive an accounting report. The analysis server 160 may receive a plurality of accounting reports from different routers 120. The analysis server 160 may regularly receive an accounting report from a router 120 for a sub-interval. The sub-interval may be shorter than the interval for the aggregated metrics. Accordingly, the analysis server 160 may expect to receive a plurality of accounting reports from a router 120 during an interval.

In step 415, the analysis server 160 may apply an application filter to the received accounting reports. The application filter may be configured by a network operator or analyst to select desired metrics for an application or subscriber. The analysis server 160 may extract measurements from the accounting reports to use as metrics.

In step 420, the analysis server 160 may assign partitions and sub-partitions to the measurements. In an exemplary embodiment, the partition is the day of the week and the sub-partition is the hour of the day. Analysis server 160 may assign a DAY_ID 320 and INT_ID 325 to each measurement based on the time indicated in the accounting report.

In step 425, the analysis server 160 may determine whether additional accounting reports will be received. Analysis server 160 may determine whether it has received an expected number of accounting reports for an interval. Analysis server 160 may also determine whether reports have been received from each server 120. If the analysis server 160 has received or expects to receive additional accounting reports, the method 400 may return to step 410 for processing the additional reports. If the analysis server 160 does not expect additional reports, the method may proceed to step 430.

In step 430, the analysis server 160 may aggregate data according to the partition and sub-partition. The analysis server may aggregate all measurements that have the same partition and sub-partition. Accordingly, the analysis server 160 may use the DAY_ID 320 and INT_ID 325 to select measurements having the same partition and sub-partition to aggregate.

In step 435, the analysis server 160 may determine a rolling baseline for a time interval. The analysis server 160 may query metric database 240 for aggregated metrics having a DAY_ID field 320 and INT_ID field 325 matching the current time. The query may also be limited to a certain number of the most recent results being the most relevant. The analysis server 160 may then calculate the baseline as a weighted average of the returned metrics. A weight may be applied to each returned metric based on a decaying function such that the most recent metrics are given the highest weight. By placing greater weight on the more recent metrics, the rolling baseline may track changes as usage patterns change. The analysis server 160 may also calculate maximum and minimum values for the metric to provide additional information regarding the rolling baseline. In various embodiments, the analysis server 160 may use a previously computed baseline to determine a rolling baseline. By averaging a previous baseline with the most recent metric, the weight of previous metrics may naturally decay.

In step 440, the analysis server may receive a current measurement for a metric. The current measurement may be in the form of an accounting report. In various embodiments, the current measurement may be a most recently aggregated metric determined based on a plurality of accounting reports. The current measurement may describe the current state of the network.

In step 445, the analysis server 160 may determine whether the current measurement is anomalous. The analysis server 160 may compare the current measurement with the rolling baseline. Because the rolling baseline and the current measurement relate to the same time of day and day of week, cyclical changes in network traffic may be eliminated. The analysis server 160 may use a variety of methods to determine whether the current measurement is significantly different than the baseline and therefore anomalous. The analysis server 160 may calculate a percentage change over the baseline or use pre-determined thresholds to determine whether a difference between the current measurement and the rolling baseline constitutes an anomaly. The analysis server 160 may also take into account minimum and maximum values of the metric. Additional methods of comparing the current measurement to the rolling baseline will be apparent to those of skill in the art. If the analysis server 160 determines that the current measurement is anomalous, the method 400 may proceed to step 450. If the analysis server 160 determines that the current measurement is within a normal range based on the rolling baseline, the method 400 may proceed to step 455, where the method ends.

In step 450, the analysis server 160 may report a detected anomaly. The analysis server 160 may automatically generate a report whenever an anomaly is detected. The analysis server 160 may send reports to a network operator or a policy server 150. Reports to a network operator may include graphs or other information to help the network operator understand the anomaly. Reports to a policy server 150 may be formatted such that a policy server 150 may take management actions in response to the anomaly. For example, analysis server 160 may report a congestion anomaly and policy server 150 may be configured to respond to a congestion anomaly by restricting bandwidth or quality of service (QoS) for an application experiencing a sudden spike in usage.

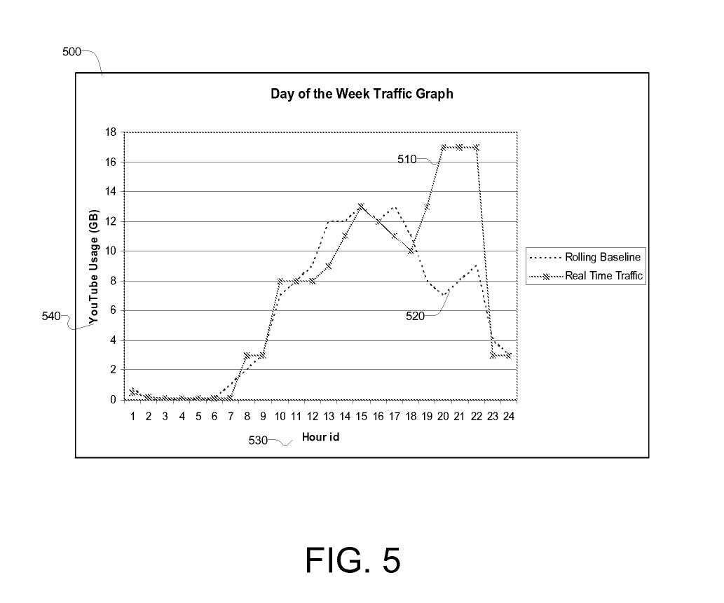

FIG. 5 illustrates an exemplary chart 500 comparing real-time measurements 510 to a rolling baseline 520. Report generator 270 may generate a chart similar to chart 500 when reporting anomalies. As an example, chart 500 may use an interval identifier 530 as the independent variable a metric measurement 540 such as total bits as the dependent variable. As shown in chart 500, the real-time traffic measurement 510 may generally track the rolling baseline 520. However, for hours 19-22, the real-time traffic measurement 510 may diverge from the rolling baseline 520. An operator viewing chart 500 may view the divergent measurement 510 as an anomaly. The analysis server 260 may also determine whether the illustrated measurements are anomalous. For example, analysis server 260 may determine that hour 19 does not indicate a significant difference from the rolling baseline 520, but that the difference for hours 20-22 is a significant anomaly.

According to the foregoing, various exemplary embodiments provide for application-aware anomaly detection. In particular, by using rolling baselines indicating normal network performance for a given time, an analysis server may identify anomalies in current network performance in a continuous and self-managed manner.

It should be apparent from the foregoing description that various exemplary embodiments of the invention may be implemented by hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of detecting anomalies in network traffic, the method comprising:
receiving a plurality of accounting reports from an application assurance device, the accounting reports indicating a metric of network performance;
aggregating the metric from a plurality of accounting reports to determine a plurality of aggregated metrics corresponding to a plurality of intervals;
storing the aggregated metrics in a database in association with the corresponding plurality of intervals;
determining a rolling baseline for a current time period based on metrics of intervals corresponding to a primary partition and a sub-partition;
comparing a metric for a current time period to the rolling baseline; and
determining that an anomaly is occurring if the metric for the current time period differs from the rolling baseline by more than a pre-defined threshold.

2. The method of claim 1, wherein the primary partition and the sub-partition are cyclical.

3. The method of claim 2, wherein the primary partition is the day of the week and the sub-partition is the interval within the day.

4. The method of claim 3, wherein the interval is an hour.

5. The method of claim 4, wherein the metric in the accounting reports define a metric for a sub-interval.

6. The method of claim 1, wherein the accounting reports indicate a metric of network performance in relation to an application.

7. The method of claim 1, wherein the accounting reports indicate a metric of network performance in relation to a subscriber.

8. The method of claim 1, wherein the step of determining a rolling baseline for a current time period comprises calculating a weighted average of aggregated metrics for intervals corresponding to the primary partition and sub-partition of the current time period.

9. The method of claim 8, wherein the weighted average applies a decayed weighting function to the aggregated metrics according to the age of each interval.

10. The method of claim 8, wherein the weighted average includes an operator selected weighted component.

11. The method of claim 1, further comprising displaying a graph comparing the rolling baseline to the metrics for a plurality of recent current time periods.

12. An analysis server for detecting network anomalies comprising:
a router interface configured to receive a plurality of accounting reports from an application assurance device, the accounting reports indicating a metric of network performance;
a non-transitory database configured to store aggregated metrics from a plurality of accounting reports in association with a corresponding plurality of intervals;
a baseline calculator configured to determine a rolling baseline for a current time period based on a subset of the stored aggregated metrics having intervals corresponding to a primary partition and a sub-partition of the current time period; and
an anomaly detector configured to compare a metric for a current time period to the rolling baseline and determine that an anomaly is occurring if the metric for the current time period differs from the rolling baseline by more than a pre-defined threshold.

13. The analysis server of claim 12, further comprising an operator interface including a display configured to display a graph comparing the rolling baseline to the metrics for a plurality of recent current time periods.

14. The analysis server of claim 12, further comprising a metric aggregator configured to aggregate a plurality of metrics from a plurality of accounting reports and assign a partition and sub-partition to each aggregated metric.

15. The analysis server of claim 12, wherein the baseline calculator is configured to determine the rolling baseline for a current time period by calculating a weighted average of aggregated metrics for intervals corresponding to the primary partition and sub-partition of the current time period.

16. The analysis server of claim 15, wherein the baseline calculator applies a decayed weighting function to the aggregated metrics according to the age of each interval.

17. A non-transitory machine-readable storage medium encoded with instructions executable by a processor of an analysis server for detecting anomalies in network traffic, the non-transitory machine-readable storage medium comprising instructions for:
receiving a plurality of accounting reports from an application assurance device, the accounting reports indicating a metric of network performance;
aggregating the metric from a plurality of accounting reports to determine a plurality of aggregated metrics corresponding to a plurality of intervals;
storing the aggregated metrics in a database in association with the corresponding plurality of intervals;
determining a rolling baseline for a current time period based on metrics of intervals corresponding to a primary partition and a sub-partition;
comparing a metric for a current time period to the rolling baseline; and
determining that an anomaly is occurring if the metric for the current time period differs from the rolling baseline by more than a pre-defined threshold.

18. The non-transitory machine-readable storage medium of claim 17, wherein the instructions for determining a rolling baseline for a current time period comprise instructions for calculating a weighted average of aggregated metrics for intervals corresponding to the primary partition and sub-partition of the current time period.

19. The non-transitory machine-readable storage medium of claim 18, wherein the weighted average applies a decayed weighting function to the aggregated metrics according to the age of each interval.

20. The non-transitory machine-readable storage medium of claim 17, wherein the primary partition and the sub-partition are cyclical, the primary partition is the day of the week, he sub-partition is the hour within the day, and the metric in the accounting reports define a metric for a sub-interval.
